(19) United States
(12) Patent Application Publication
(10) Pub. No.: US 2025/0286418 A1
(43) Pub. Date: Sep. 11, 2025

(54) ELECTRIC MACHINE SUBASSEMBLY

(71) Applicant: 1478021 B.C. LTD., Surrey BC (CA)

(72) Inventors: Frantisek ZATKO, Wichita, KS (US); Amirmasoud TAKBASH, Wichita, KS (US); Keith Wilson KLONTZ, Wichita, KS (US)

(21) Appl. No.: 18/859,626

(22) PCT Filed: May 3, 2023
(86) PCT No.: PCT/IB2023/054602

§ 371 Date: Oct. 24, 2024

(30) Foreign Application Priority Data
May 6, 2022 (GB) 2206627.8

(51) Int. Cl. H02K 1/30; H02K 1/2783; H02K 15/035

(52) U.S. Cl. CPC H02K 1/30; H02K 1/2783; H02K 15/035

(57) ABSTRACT

A subassembly for an electric machine comprising: a hub comprising: a first set of teeth, the first set of teeth defining post-receiving gaps between adjacent teeth of the first set and; a second set of teeth defining post-receiving gaps between adjacent teeth of the second set, the second set being spaced from the first set and defining magnet-receiving gaps therebetween; a plurality of permanent magnets arranged within the magnet-receiving gaps; and a plurality of ferrous posts arranged within the post-receiving gaps and between the permanent magnets.

### RELATED APPLICATIONS

This application claims priority to GB Patent Application No. 2206627.8 filed on May 6, 2022, which is incorporated herein by reference in its entirety.

### FIELD OF THE INVENTION

This invention relates to a subassembly for an electric machine, and to an electric machine incorporating the subassembly. In particular, the subassembly may be a rotor or a stator of an electric machine, generally referred to as a carrier of an electric machine. This invention also relates to a method for constructing a subassembly for an electric machine. The electric machine may be a motor or a generator.

### BACKGROUND

When constructing electric machines, it is known to have a subassembly that has powered electromagnetic elements and a relatively rotatable subassembly that has permanent magnets. These portions may be arranged as a rotor and stator with the permanent magnets in either of the rotor or the stator. Within the subassembly that has permanent magnets, it is desirable to have a ferrous portion that may direct the magnetic flux from the permanent magnets towards the powered electromagnets. However, the construction of such subassemblies may be complex and there is also a desire to reduce the weight of such subassemblies.

### SUMMARY

According to a first aspect of the invention, there is provided a subassembly for an electric machine comprising: a hub comprising: a first set of teeth, the first set of teeth defining post-receiving gaps between adjacent teeth of the first set and; a second set of teeth defining post-receiving gaps between adjacent teeth of the second set, the second set being spaced from the first set and defining magnet-receiving gaps therebetween; a plurality of magnetic elements arranged within the magnet-receiving gaps; and a plurality of ferrous posts arranged within the post-receiving gaps and between the magnetic elements.

There is also provided a subassembly for an electric machine comprising: a hub comprising a first set of radially-extending teeth defining post-receiving gaps circumferentially therebetween and a second set of radially extending teeth defining post-receiving gaps circumferentially therebetween, the second set being axially spaced from the first set such that the first set of teeth and the second set of teeth define magnet-receiving gaps axially therebetween; a plurality of magnetic elements arranged within the magnet receiving gaps; and a plurality of ferrous posts arranged circumferentially between the magnetic elements.

With such an arrangement, the hub may be formed from a non-ferrous material. As such, the hub may be lighter and stronger than known subassembly parts, providing a lighter and stronger motor overall. Further, since the hub and the ferrous posts may be formed separately, whether the hub may be ferrous or not, the magnetic elements may be arranged within the subassembly in a more simple manner and may be held in place by the ferrous posts. Construction of the subassembly may therefore be simplified.

By providing a non-ferrous hub, the magnetic flux of the magnets may be more efficiently transferred into an air gap of an electric machine. In some cases, there may be no ferrous material radially inside the magnets in the case where the magnets are radially outside the hub. Generally, there may be no ferrous material on an opposite side of the magnets from an airgap of an electric machine incorporating the subassembly.

The teeth may have an outwardly extending extent, that may be a radial extent, substantially similar to the extent of the posts in the same direction. Additionally or alternatively, the teeth may have an outwardly extending extent, which may be a radial extent, substantially similar to the extent of the magnets in the corresponding direction. In this way, the teeth of the hub may support the magnetic elements and/or the posts along the entire length of the teeth in the outwardly extending direction. In this way, the rotor may be made stronger and the magnets and posts may be better protected. It is noted that the radial extent of an integer may be considered as the distance between the outer diameter of the integer and the inner diameter of the integer when the integer is installed within the subassembly. In the case of the teeth, it will be understood that the hub may have a castellation shape, with outer surfaces of the teeth defining an outer diameter and the bottoms of troughs or valleys between the teeth defining an inner diameter. The radial extent of the teeth may therefore be considered as the amplitude, or radial distance, between the bottoms of the troughs and the outer surfaces, measured radially.

The magnetic elements may have a tapered shape, and the teeth may also have a tapered shape. The tapered shape may allow easier insertion of the magnetic elements into the magnet-receiving gaps and of the posts into the post-receiving gaps. The insertion of the magnetic elements may be axially between the teeth, and of the posts circumferentially between the teeth and magnets, the insertion being in a radial direction. The tapered shape may also improve conduction of the flux through the subassembly by increasing a surface area in contact between the magnets and the posts.

The magnetic elements and/or teeth each have a circumferential width which is less at a radially outward location than at a radially inward location. The magnetic elements and/or teeth may therefore taper in a radially outward direction. This may improve the ease with which the subassembly may be manufactured with the magnetic elements and posts being inserted from a radially outward direction.

The magnetic elements and the teeth may have cross-sectional areas that are of the same size and shape. The cross-sectional areas may be taken in a plane perpendicular to an axis of the subassembly. In this way, the magnetic elements and the teeth may be axially aligned, such that ferrous posts having a flat surface may abut both of the teeth and the magnetic elements simultaneously. The teeth may also provide protection to the magnetic elements by covering their axial end faces completely.

The ferrous posts may have a tapered shape. The tapered shape of the ferrous posts may be arranged to tessellate with the tapered shape of the magnetic elements and/or the teeth. The tapered shape may allow the ferrous posts to be inserted more easily between the teeth and may also improve the conduction of magnetic flux from the subassembly.

The ferrous posts may have a width, which may be in a circumferential direction, that is greater at an outward location than at an inward location. The taper may be in a radial direction. This may allow the ferrous posts to be inserted more easily, for example in a radially inward direction.

The hub may be made from a non-ferrous material. Optionally, the hub may be made from a non-ferrous metal or alloy, such as aluminium. This may allow a stronger and lighter subassembly to be formed.

The post-receiving gaps may have a tapered shape and may have a greater width, which may be a circumferential width, at an outward location and a smaller width at an inward location. The taper may be in a radial direction. The post receiving gaps may have substantially the same size and shape as the posts.

The posts may abut surfaces of the teeth facing the post-receiving gaps. In this way, the posts may be held in place at least partially by abutment with the teeth. The posts may also be adhered, bonded or welded to the teeth.

The subassembly may further comprise a retaining ring arranged to maintain the position of the magnetic elements and/or posts relative to the hub. The retaining ring may be a sleeve arranged to abut and/or cover a radially outer surface of each of the magnetic elements and posts. The sleeve may exert a more even retaining force onto the magnetic elements and the posts. This may be particularly advantageous where the posts are laminated or the magnetic elements are segmented, in order to avoid bending stresses being generated within the posts.

The posts may comprise a stepped portion, the stepped portion having a surface arranged to receive a retaining member. Additionally or alternatively, the magnetic elements may comprise a stepped portion arranged to receive a retaining member. The stepped portion of the magnetic elements and/or posts may therefore allow the magnetic elements and/or posts to be held resiliently in place by a retaining member. The retaining member may also be located away from the outer diameter of the subassembly, meaning that the outer surfaces of the magnetic elements and the ferrous posts may be closer to an adjacent subassembly, effectively reducing the size of an air gap between the rotor and stator of an electric machine.

The stepped portions may extend away from bodies of the posts and/or magnetic elements, such as extending away in an axial direction, and may have an outwardly extending extent, such as a radial extent, less than that of the bodies, optionally less than half the corresponding extent of the bodies.

The teeth may comprise further stepped portions arranged to receive a retaining member. In this way, the posts and/or magnetic elements may be more resiliently held in place, and the peak stresses on each stepped portion may be reduced.

The subassembly may further comprise a retaining ring arranged to abut the stepped portions and/or the further stepped portions and to maintain the position of the magnetic elements and/or posts relative to the hub. The retaining ring may also allow the elements of the subassembly to be maintained in place removably and there may be no need for the use of adhesive. This may provide a more simple and more resilient construction method.

The subassembly may be symmetrical about a plane perpendicular to an axis through the subassembly.

Each post, each magnetic element, and/or the hub may be formed separately and integrally. Each post, each magnetic element, and/or the hub may be formed from a single piece.

Each post may be laminated and/or each magnetic element may be segmented. The posts may each be formed from a plurality of laminae, each lamina being planar in a plane perpendicular to the axis. The magnetic elements may each comprise an array of axially aligned, separate magnetic elements. This may reduce the generation of eddy currents within the magnetic elements and posts.

Each post may have a recess arranged to face the hub. The recess may be arranged to fix the post to the hub by receiving a retaining member or a retaining means, such as an interlocking member or an adhesive. The recess may extend through the post in an axial direction. The posts may be coupled to the hub by an adhesive and the adhesive may at least partially fill the recess.

The posts and the magnetic elements may be coupled to the hub by an adhesive and the adhesive may separate radially inner surfaces of the posts and radially inner surfaces of the magnetic elements from the hub. This may provide improved magnetic isolation of the magnetic elements and posts from the hub and may also allow absorption of vibrations between the hub and the magnetic elements and post.

The subassembly may comprise an airgap-facing surface arranged to face the airgap of an electric machine into which the subassembly is to be incorporated. The surface may comprise surfaces of the magnets and/or the posts of the assembly. The surface or surfaces may be subject to, or may have been subject to, a post-assembly material removal process, to provide a machined surface comprising surfaces of the magnets and/or the posts. This step may to apply a common surface-dimension, such as a surface-height or a surface-radius, to the surfaces of the magnets and/or the posts of the assembly. The surface-dimension may be measured in an outwardly extending direction of the posts and/or magnets. Such a process can provide a more uniform airgap-facing surface, allowing the air-gap in the machine to be reduced and performance of the machine increased.

The subassembly may be a rotor, optionally a rotor for use in a radial flux electric machine.

The rotor may be arranged to be received inside a stator of an electric machine or may be arranged to have a stator received within in. The rotor may be used in an in-runner or an out-runner arrangement.

According to a second aspect of the invention, there is provided an electric machine incorporating a stator and a rotor according to the first aspect. The rotor may be arranged radially inside the stator or radially outside the stator.

The electric machine may be an electric motor arranged to generate a torque by electromagnetic interaction between the rotor and the stator when electrical current is supplied to the electric machine, or a generator arranged to generate electricity due to electromagnetic interaction between the rotor and stator when a torque is imparted to the rotor.

According to a third aspect of the invention, there is provided a method of constructing a subassembly for an electric machine, the method comprising: providing a hub, the hub comprising: a first set teeth, the first set of teeth defining post-receiving gaps between adjacent teeth of the first set, and a second set of teeth, the second set of teeth defining post-receiving gaps between adjacent teeth of the second set, the second set being spaced from the first set and defining magnet-receiving gaps therebetween; inserting a plurality of magnetic elements into the magnet receiving gaps; and inserting a plurality of ferrous posts between the magnetic elements.

There is also provided a method of constructing a subassembly for an electric machine, the method comprising: providing a hub comprising a first set of radially-extending teeth, the first set of teeth defining post-receiving gaps circumferentially therebetween and a second set of radially extending teeth defining post-receiving gaps circumferentially therebetween, the second set being axially spaced from the first set such that the first and second sets of teeth define magnet-receiving gaps axially therebetween; inserting a plurality of magnetic elements into the magnet receiving gaps; and inserting a plurality of ferrous posts circumferentially between the magnetic elements.

The method of constructing the subassembly may be more simple than known methods of assembling subassemblies, and may provide a subassembly that is lighter and/or stronger than known subassemblies.

The magnetic elements and/or posts may comprise a stepped portion having a surface arranged to receive a retaining member.

The teeth may comprise further stepped portions arranged to receive a retaining member.

The method may further comprise securing the magnetic elements and posts to the hub by applying a retaining ring to the stepped portions and/or the further stepped portions such that the retaining ring maintains the position of the magnetic elements and/or posts relative to the hub.

The method may further comprise the step of performing a material removal process on surfaces of the magnets and/or posts which are arranged to face an airgap of an electric machine into which the subassembly is to be incorporated. The surfaces of the magnets and/or the posts of the assembly may together form a combined surface. The surface may be subjected to a post-assembly material removal process, to provide a machined surface comprising surfaces of the magnets and/or the posts. This step may apply a common surface-dimension, such as a surface-height or a surface-radius, to surfaces of the magnets and/or the posts of the assembly. The surface-dimension may be measured in an outwardly extending direction of the posts and/or magnets. Such a process can provide a more uniformly dimensioned airgap-facing surface or surfaces, allowing the air-gap in the machine to be reduced and performance of the machine increased.

According to a fourth aspect of the invention, there is provided a subassembly for an electric machine comprising: a hub comprising: a first set of teeth, the first set of teeth defining first gaps between adjacent teeth of the first set and; a second set of teeth defining first gaps between adjacent teeth of the second set, the second set being spaced from the first set and defining second gaps therebetween; and a plurality of magnetic elements arranged within the first and second gaps; wherein the magnetic elements are arranged in a Halbach array.

The magnetic elements may comprise: radially polarised magnetic elements arranged in the first gaps, circumferentially between the teeth; and circumferentially polarised magnetic elements arranged in the second gaps, axially between the teeth. Alternatively, the magnetic elements may comprise: circumferentially polarised magnetic elements arranged in the first gaps, circumferentially between the teeth; and radially polarised magnetic elements arranged in the second gaps, axially between the teeth.

The magnetic elements may be permanent magnets. The use of permanent magnets in rotors may be particularly useful for constructing brushless electric machines. Alternatively, the magnetic elements may be electromagnetic elements, such as electrical coils, which optionally may have a ferrous core.

### BRIEF DESCRIPTION OF THE DRAWINGS

FIG. 1 shows a general view of a hub for a subassembly according to embodiments of the invention;

FIG. 2 shows a magnet for use in a subassembly according to embodiments of the invention;

FIG. 3 shows a post for use in a subassembly according to embodiments of the invention;

FIG. 4 shows a general view of a partially assembled subassembly according to embodiments of the invention;

FIG. 5 shows a subassembly according to embodiments of the invention;

FIG. 6 shows an alternative hub for use in a subassembly according to embodiments of the invention;

FIG. 7 shows a magnet for use in the alternative subassembly according to embodiments of the invention;

FIG. 8 shows an alternative post for use in the alternative subassembly according to embodiments of the invention;

FIG. 9 shows a partially assembled state of the alternative subassembly according to embodiments of the invention;

FIG. 10 shows a further, partially assembled state of the alternative subassembly according to embodiments of the invention;

FIG. 11 shows the alternative subassembly according to embodiments of the invention;

FIG. 12 shows a further alternative post for use in a further alternative subassembly according to embodiments of the invention;

FIG. 13 shows an alternative magnet for use in a still further alternative subassembly according to embodiments of the invention;

FIG. 14 shows a still further alternative post for use in a still further subassembly according to further embodiments of the invention;

FIG. 15 shows a still further subassembly arrangement according to embodiments of the invention;

FIG. 16 shows a post for use in the still further subassembly;

FIGS. 17 and 18 show a variation of the still further subassembly according to embodiments of the invention;

FIG. 19 shows a further variation of the still further subassembly according to embodiments of the invention;

FIG. 20 shows a subassembly according to embodiments of the invention having a Halbach array;

FIG. 21 shows an electric machine incorporating a subassembly according to embodiments of the invention; and

FIG. 22 shows a further electric machine incorporating a subassembly according to embodiments of the invention.

### DETAILED DESCRIPTION OF THE PREFERRED EMBODIMENTS

This invention relates to a subassembly for an electric machine. The subassembly may be a rotor or a stator and may be referred to more generally as a carrier. It will be understood that in some cases a rotor may have permanent magnets and be rotatable about an axis, with a stator having electromagnets providing a changing magnetic field, the changing magnetic field affecting the rotor and thereby generating a torque. Alternatively, a stator may have permanent magnets and a rotor may have electromagnets with a changing magnetic field, which generates a torque by virtue of the interaction with the permanent magnets of the stator. The magnetic field in the rotor or stator may alternatively be induced by a current applied to the rotor or stator in order to generate a torque in the rotor, or the rotor may have an external torque applied to it, such that the rotor applies a changing magnetic field to the stator to induce an electric current, as in the case of a generator. The subassembly of the present invention may therefore be a stator having permanent magnets or a rotor having permanent magnets and may be in an electric motor or an electric generator.

Further, a stator may be arranged radially outside a rotor or a stator may be arranged radially inside a rotor, the latter configuration being known as an outrunner arrangement. The subassembly of the present invention may be the radially outer part or the radially inner part and the components of the subassembly may be shaped accordingly.

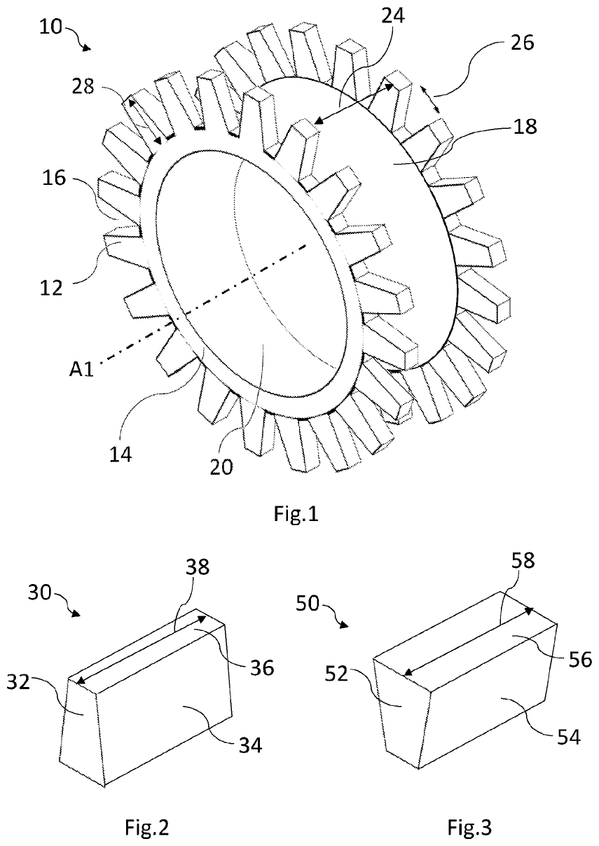

FIG. 1 shows a hub 10 for use in a subassembly having an axis A1. The hub 10 may form a body of a rotor for insertion concentrically within a stator within a radial flux electric machine. A direction parallel with the axis may be described as an axial or longitudinal direction, a direction away from the axis may be described as an outward or radial direction, and a direction around the axis may be described as a lateral or circumferential direction.

The hub 10 has teeth 12 extending from a cylindrical, annular central portion 14. The central portion 14 may be hollow. While the hub 10 shown has 20 teeth 12, it will be understood that the hub may have a higher or lower number of teeth. The teeth 12 extend radially outwardly from the central portion 14 in a similar manner to the teeth of a gear. The teeth 12 have a trapezoidal shape, which is narrower at a radially outward location and wider at a radially inward location. However, it will be understood that the teeth may alternatively have a rectangular shape with constant thickness in a circumferential direction. Other curved or rounded profiles of the teeth, providing the post-receiving gaps 16 between the teeth, may also be envisaged.

The teeth may have a substantially constant axial depth (i.e. in a direction parallel to the axis of rotation of the rotor A1. This may provide planar end faces of the hub and planar internal axial faces of the teeth 12. The teeth 21 may have a planar face perpendicular to the axis A1 on an axially outward side, and on an axially inner side the teeth may have a planar face with a plane normal to the axis, or the teeth may be tapered such that the axial depth of the teeth increases in a radially inward direction and is less at a radially outward location. In this case, the teeth may have axially outer planar end faces perpendicular to the axis A1 and axially inner planar end faces angled, or non-perpendicularly oriented, relative to the axis A1.

The teeth 12 extend radially outward from the central portion 14, which has a cylindrical outer surface 18, and the radial extent of the teeth may be considered as the distance the teeth extend from the cylindrical surface 18. The cylindrical surface 18 may act as a support for posts and magnets abutting it. The surface 18 may therefore be formed as a cylinder or as a polygon, to allow improved tessellation with the posts and magnets, depending on whether the posts and magnets have flat or curved radially inner faces abutting the surface 18.

Between the teeth 12, there are provided post-receiving gaps 16, which are circumferentially between the teeth 12. There are two axially spaced sets of teeth 12, with each set having a respective set of post-receiving gaps 16 circumferentially between the teeth 12. The width of the post-receiving gaps 16 is greater at a radially outward location and less at a radially inward location, as indicated by the arrow 26, which shows the width of the post-receiving gaps 16.

Magnet-receiving gaps are provided axially between the teeth 12, the magnet receiving gaps having an axial depth indicated by arrow 24. Since the teeth 12 may have axially inner faces that are normal to the axis A1 or angled relative to the axis A1, the magnet-receiving gaps may have axial depths that are constant in a radial direction or which reduce radially inwardly.

FIG. 2 shows a magnet 30, which may be positioned within the magnet-receiving gaps 24 of the hub 10. The magnet 30 has an axial end face 32, which is planar and normal to the axis A1 in this case, but which may be tapered. The end face 32 has a trapezium shape. A side face 34 arranged to face in a circumferentially radially outward direction has a rectangular shape. A radially outwardly facing face 36 also has a rectangular shape. While all the faces are shown as being planar, it will be understood that any of the faces may be curved, and that the hub 10 and/or posts 50 may have corresponding curved surfaces in order to tessellate with the magnets 30. The magnet 30 has an axial depth indicated by arrow 38, which may be the same as the axial depth 24 of the magnet-receiving gaps of the hub 10.

FIG. 3 shows a ferrous post 50, which may be formed of soft iron and may be monolithic soft iron or may be laminated. The ferrous post 50 has an axial depth 58, which may be greater than the axial depth 38 of the magnet 30. The axial depth 58 of the post 50 may be the same as the sum of the axial depth of two teeth (i.e. one tooth of each of the two axially spaced sets of teeth) and of the magnet 30, such that an axial end face 52 of the post 50 is coplanar with an axially outer face of the teeth 12 when the subassembly is assembled. The axial end face 52 of the post 50 may also be shaped trapezoidally in order to tesselate with the teeth 12 and to fill the post-receiving gaps 16 adjacent the magnets 30. The post 50 also has a side face 54, which is arranged to abut and to tesselate with the corresponding side face 34 of the magnets 30 and with the tapered side faces of the teeth 12. The radially outer end faces 56, 36 of the post 50 and of the magnet 30 may be arranged to form an outer surface of the subassembly 10, which may face an air gap and/or a stator located radially outside the rotor 10.

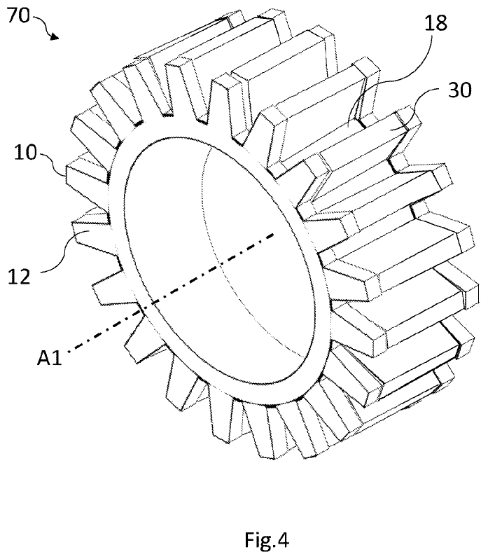

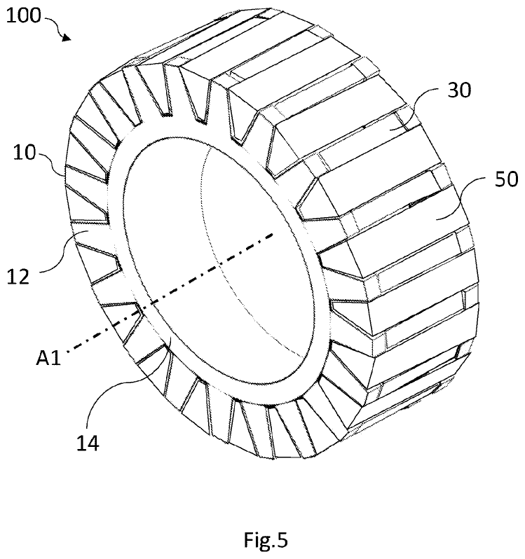

FIG. 4 shows a partially assembled subassembly 70 at an intermediate stage of manufacture. At this stage, the subassembly 70 comprises the hub 10 and the magnets 30. It can therefore be seen that the magnets 30 may be inserted into the hub 10 before the posts 50 are inserted. In alternative sequences of assembly steps, the magnets and posts may be inserted in sets of magnets 30 and corresponding posts 50, around the hub so that magnets 30 and posts 50 are provided to the hub 10 in parallel, rather than all magnets 30 being applied to the hub 10 before all posts 50 are applied. The magnets 30 can be arranged axially between axially aligned teeth 12 and abut the cylindrical outer surface 18. The magnets 30 can also have side faces aligned with the tapered surfaces of the teeth 12 such that substantially planar surfaces are formed by the side faces of the teeth 12 of the hub 10 and the side faces 34 of the magnets 30 together.

FIG. 5 shows an assembled subassembly 100 including the hub 10, the magnets 30 and the posts 50. It can be seen that together the components of the subassembly 100 form a substantially cylindrical outer surface. The components may be coupled by being glued or welded, or may be held together by an outer retaining band.

It will be understood that the magnets may be held in place axially by abutment with the teeth 12, held in place radially by abutment with the inner cylindrical surface 18 and held circumferentially by abutment with the posts 50. The posts 50 may also prevent radially outward movement of the magnets 30 by abutment therewith. Therefore, if the posts 50 are fixed relative to the hub 10, then the rotor subassembly 100 may be formed with all components held in place.

The rotor may be provided with an adhesive potting compound or resin in order to secure each element in place. Further, the airgap-facing surface of the rotor may be machined, such as on a lathe, or ground, or subject to another material removal process, in order to provide a uniform surface, which may provide a cylindrical outer surface concentric with the axis A1. The surface may be constant and may comprise surfaces of both post and magnets, or may be non-constant, comprising, for example, surfaces of only the posts or only the magnets. Each subsection of the surface may be subjected to the material removal process, which may be a common material removal process, to provide a common surface dimension to the surface of the component or components. A person skilled in material removal processes will be able to determine where multiple surfaces of different subcomponents have been subject to a common material removal step, for example by macroscopic or microscopic inspection of abrasion lines or striations created by the material removal process, and by inspection of how they cross boundaries or gaps between, and continue over, surfaces of adjacent or sequential subcomponents in the subassembly.

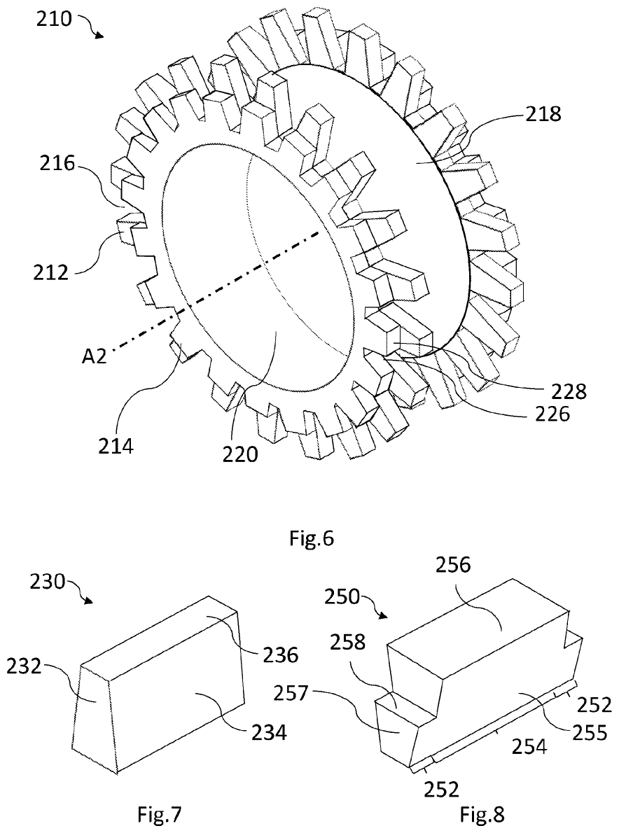

FIG. 6 shows an alternative hub 210 for use in a subassembly according to further embodiments. While substantially similar parts of the hub 210 to the hub 10 will not be redescribed here, it is noted that the hub 210 has an axis A2 and teeth 212 with post-receiving gaps 216 circumferentially between the teeth and magnet-receiving gaps axially between the teeth 212. The hub 210 also has a cylindrical surface 218 for supporting the magnets and/or posts to be received by the hub 210. In addition to the previously described hub 10, the hub 210 has stepped portions 214 extending axially outwardly from the teeth 212. The stepped portions have side faces 226 which are aligned with the side surfaces of the teeth 212 so as not to interrupt the post-receiving gaps, which extend between the stepped portions 214 circumferentially, and so that the side faces 226 of the stepped portions 214 may abut the posts. The stepped portions also have radially outer surfaces 228, the radially outer surfaces 228 of the stepped portions extending from the teeth 212 at approximately half the height of the teeth 212 and being shaped for receiving a retaining member thereon. The radially outer surfaces 228 of the stepped portions 214 may therefore each form portions of the same cylindrical surface. It will be understood that the hub 210 has two sets of stepped portions 214, each set extending axially outwardly from a respective set of teeth 212, such that two retaining rings may be received on the hub 210.

FIG. 7 shows a magnet 230 for insertion into the hub 210. It will be noted that the magnet 230 is substantially identical to the magnet 30 of FIG. 2, having an axial end face 232, side face 234 and radially outer face 236, all of which may have the properties described above with reference to FIG. 2.

FIG. 8 shows a post 250 for insertion into the hub 210. The post 250 may be similar to the post 50 of FIG. 3, with the addition of stepped portions 252 extending axially therefrom. The post 250 has two stepped portions 252, each extending axially outwardly from a body portion 254 of the post 250. The stepped portions 252 each have an axial end surface 257, arranged to be substantially coplanar with the axial end surfaces of the stepped portions 214 of the hub 210 and a radially outer surface 258 which is arranged to form a substantially cylindrical surface with the radially outer surfaces 228 of the stepped portions 214 of the hub 210.

The posts 250 also have side surfaces 255, which are arranged to abut the magnets 230, and in particular are arranged to abut the side surfaces 234 of the magnets, 230 and to abut the side surfaces of the teeth 212 and stepped portions 214. Top surfaces 256 of the posts 250 are arranged to form a substantially cylindrical outer surface with the outer surfaces 236 of the magnets 230.

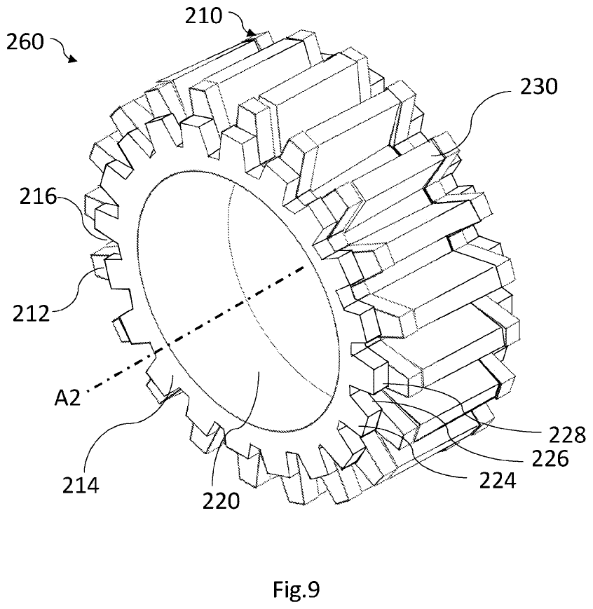

FIG. 9 shows a partially assembled subassembly 260, comprising the hub 210 and the magnets 230. As can be seen, the magnets 230 are arranged so that the radially outer and side surfaces align with the radially outer and side surfaces of the teeth 212. The axial end faces 232 of the magnets 230 abut the inner axial faces of the teeth 212 in order to constrain the magnets 230 axially. The radially inner surfaces of the magnets 230 abut the cylindrical outer surface 218 of the hub 210. As described in relation to earlier embodiments, the magnets 230 and posts 250 may be provided to the hub 210 in a parallel sequence, or so that all magnets are applied to the hub 210 before all the posts 50 are subsequently applied.

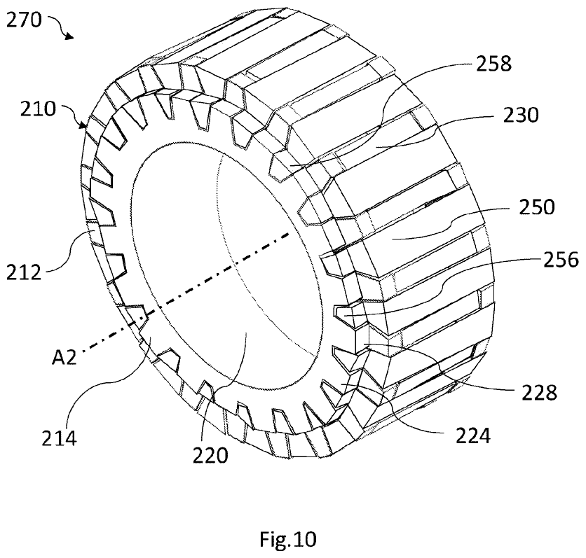

FIG. 10 shows a further partially assembled subassembly 270 at a later stage of assembly. The partially assembled subassembly 270 includes the hub 210, magnets 230 and posts 250. As can be seen, the radially outer surfaces of the magnets 230 align with the radially outer surfaces of the teeth 212 and of the posts 250 to form a cylindrical outer surface and the radially outer surfaces 258 of the stepped portions 256 of the posts 250 align with the radially outer surfaces 228 of the stepped portions 224 of the hub 210 in order to form a further cylindrical surface having a smaller radius, for receiving a retaining member.

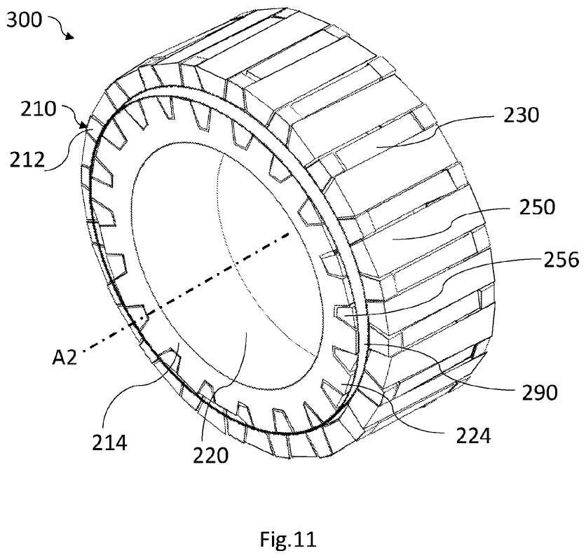

FIG. 11 shows an assembled subassembly 300 including a retaining member 290. In this case the retaining member 290 is a ring that lies along the radially outer surfaces of the stepped portions of the hub 210 and posts 250. The retaining member 290 may be formed of sprung steel, or may be heated before application such that the ring may impart a compressive force to the stepped portions. It will be understood that the subassembly 300 may comprise two retaining rings 290, which may be symmetrically arranged about a plane central to the subassembly 300 normal to the axis A2. The retaining rings may be arranged with one on either axial end of the subassembly 300, each abutting respective stepped portions of the posts and hub.

Alternatively, the retaining ring 290 may be replaced by other types of retaining member, such as arcuate retaining members, which may have arcuate extents greater than 180 degrees, or which may be adhered to the hub 210 and/or to the posts 250.

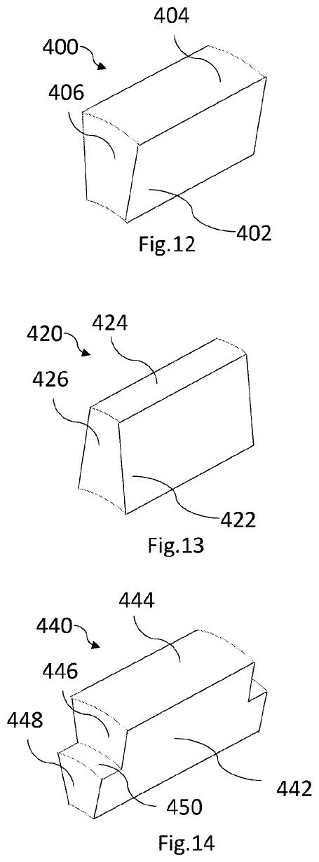

FIGS. 12 to 14 show alternative posts and magnets that may be used within the above-described arrangements or variations thereon.

FIG. 12 shows a post 400 having a curved radially outer surface 404 and a curved radially inner surface. By providing a curved inner surface, the post 400 may more closely abut the inner cylindrical surface of the hub. By providing a curved radially outer surface, the size of the air gap between the subassembly and an adjacent subassembly may be reduced. It will be understood that a post may have a curved radially inner surface and a flat radially outer surface or vice versa. The end surface 406 has an arcuate angular shape, which is a sector of an annulus. The side surface 402 may be planar and substantially similar to those of the posts described above.

FIG. 13 shows a magnet 420 having an arcuate, curved radially outer surface and an arcuate, curved radially inner surface. As described above, the curved inner surface may improve fitting between the magnet and the cylindrical surface of the hub and the curved outer surface may reduce the size of an air gap between the subassembly and an adjacent subassembly. It will be understood that a magnet may have a curved radially inner surface and a flat radially outer surface or vice versa. The axial end surface 426 may be formed as a sector of an annulus and the side surface 422 may remain substantially planar and may be substantially similar to above-described magnets.

FIG. 14 shows a further post 440, having a stepped portion with a curved radially outer surface 450, and the body portion having a curved radially outer surface 444. By providing a curved radially outer surface 450 of the stepped portion, the fitting between the post 440 and the retaining member may be improved, and stress concentrations may be reduced. The post 440 also has axial end surfaces 446, 448. The side surface 442 of the post 440 may be substantially similar to those described above.

It will be understood that there may be any combination of curved and flat surfaces for the posts and magnets such as curved radially outer surfaces and flat radially inner surfaces or flat radially outer surfaces and curved radially inner surfaces. The curvature or flatness of each surface has its own respective benefits as described above, with the drawback of manufacturing complexity and so may be selected as required.

It will also be understood that a large number of flat surfaces may co-operate to form a substantially cylindrical surface since the deviations from a cylinder may be considered as relatively small. While such a surface may be more accurately described as a polygon (in the present case a regular tetracontagon), a skilled person will recognise that the outer surface may be considered as cylindrical to a reasonable degree of accuracy. Alternatively, the respective outer surfaces may be formed as curves having a common radius of curvature, so that a more accurately cylindrical outer surface is formed.

In order to provide a more uniform surface oriented towards the airgap of the machine into which the assembly is to be assembled, a material removal process, such as grinding or machining, may be applied to airgap-facing surfaces of the assembly. The surface may be constant and may comprise surfaces of both posts and magnets, or may be non-constant, comprising, for example, surfaces of only the posts or only the magnets. Each subsection of the surface may be subjected to the material removal process, which may be a common material removal process, to provide a common surface dimension to the surface of the component or components.

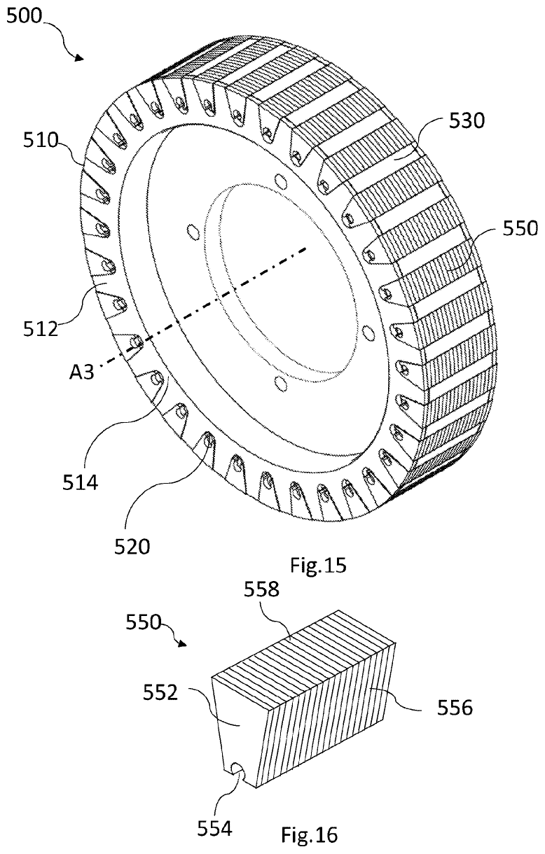

FIG. 15 shows a subassembly 500 for an electric machine, which in this case may be a rotor. The subassembly 500 has a hub 510 comprising a cylindrical portion 514 and teeth 512 extending radially outwardly from the cylindrical portion 514. The teeth have post-receiving gaps circumferentially between them and, as shown in FIG. 15, the bases of the post-receiving gaps are curved. Having curved bases joining the adjacent teeth 512 may help to reduce stress concentrations and may provide a more resilient rotor.

The magnets 530 received in the magnet receiving gaps of the hub 510 may be substantially similar to the above-described magnets of other embodiments. The posts 550 are shown in greater detail in FIG. 16 and it can be seen that the posts 550 may be laminated in an axial direction. Laminations may reduce the generation of eddy currents within the posts.

Further, the posts may have recesses 554, which may also be referred to as pockets or grooves, on a surface of the post 550 arranged to face towards the hub 510, optionally a surface arranged to face radially inwardly towards the hub 510. The pocket 554 may be arranged to receive an adhesive such as a resin or a potting compound in order to more strongly adhere the post 550 to the hub 510. Further, a line of resin may extend axially along the recess 554 in order to improve the structural strength of the post 550. This advantage may be particularly beneficial where the posts 550 are laminated.

The recess 554 may have an overlap portion such that a width of the recess 554 is greater at an internal location than at the entrance to the recess 554, the entrance being the point at which the recess 554 meets the radially innermost surface of the post 550. The overlap may act to provide an interlocking engagement with an adhesive or with a solid engagement member, such as a retaining bar, which may be metallic or may be plastic, the retaining bar being fixed to the hub 510.

The post 550 also has a radially outer surface 558 and a side surface 556 substantially similar to the posts described above.

The sub-assembly 500 may generally be provided with a layer of resin or potting compound between the hub 510 and the magnets 530 and posts 550, such that the hub 510 may not contact the magnets 530 or posts 550 and may be secured to the magnets 530 and posts 550 via the resin.

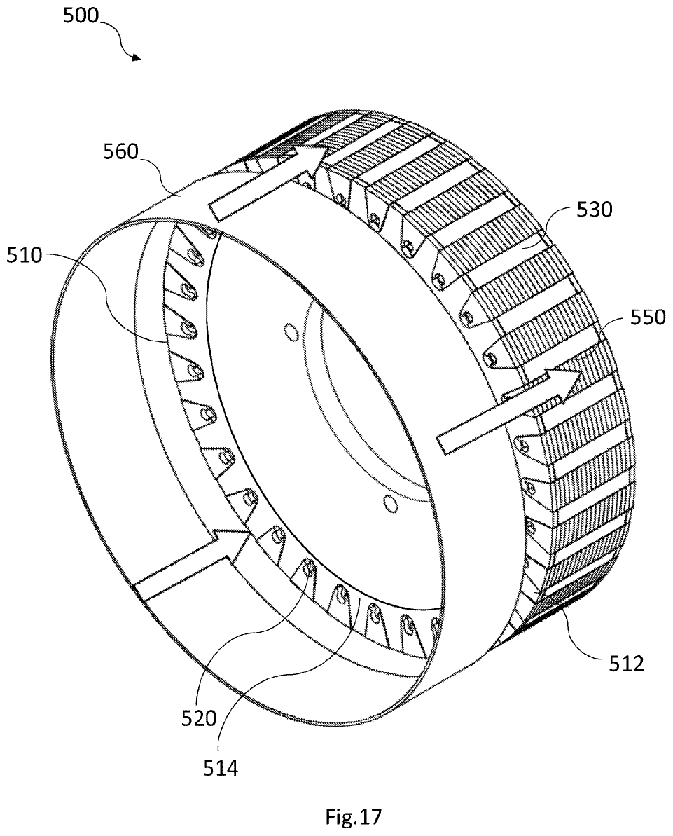

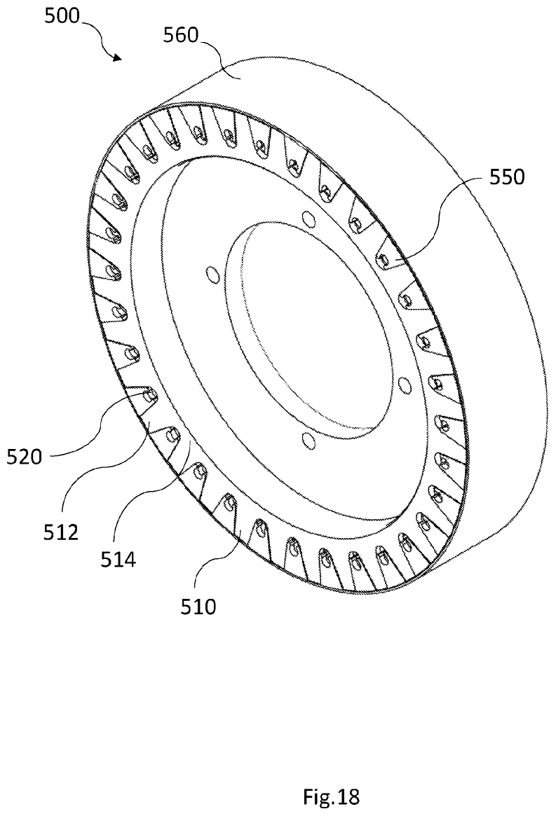

Looking to FIGS. 17 and 18, it can be seen that a sleeve 560 may be placed around the sub-assembly 500, such that the sleeve 560 may abut and may cover radially outer faces of the magnets 530 and posts 550. The sleeve 560 may have an internal tensile stress and may thereby impart a compressive force onto the sub-assembly 500 in order to maintain the magnets 530 and posts 550 in place.

The sleeve 560 may be formed from carbon fibre in order to provide a strong and light sleeve. However, Kevlar may alternatively be used and may be beneficial as Kevlar is not electrically conductive. It will be understood that any range of materials may be used for the sleeve 560. In some cases, the sleeve may be referred to as a retaining member or retaining ring.

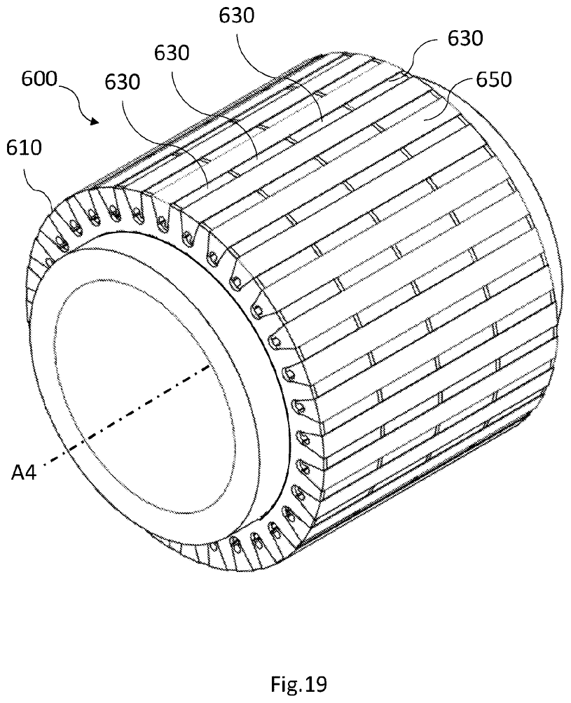

FIG. 19 shows a sub-assembly 600 having a greater axial length. The sub-assembly 600 may otherwise be substantially similar to the sub-assembly 500 shown in FIGS. 15, 17 and 18. The rotor 600 has a hub 610, posts 650 and a plurality of magnets 630. The sub-assembly 600 has a plurality of magnets 630 aligned axially a row. Therefore, around the circumference of the rotor 600, the rotor 600 has a plurality of sets of magnets 630, with a plurality of axially aligned magnets being arranged between each post 650. The magnets 630 in each array may either be described as a plurality of magnets or as a single magnet that is segmented. The segmentation of magnets in this way may reduce the generation of eddy currents within the magnets.

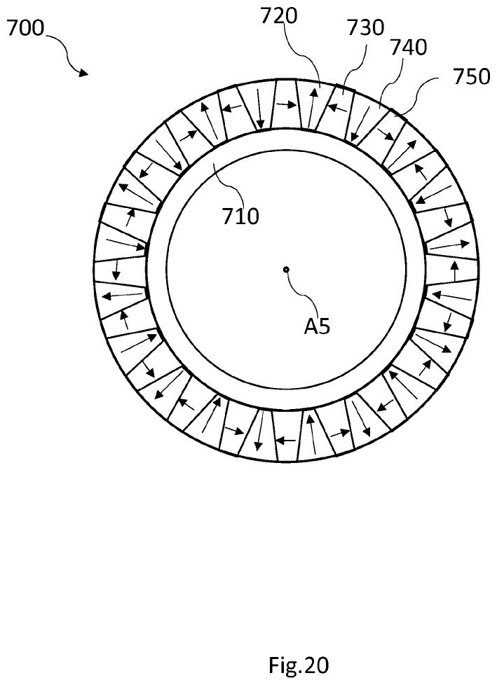

FIG. 20 shows a cross-section of a further sub-assembly 700 with polarisation directions of the magnets indicated by arrows. The assembly has a hub 710 and a plurality of magnets 720, 730, 740, 750 arranged circumferentially about the hub 710. It will be understood that the mechanical structure of the hub 710 may be substantially similar to the hubs described above, and that any aspects of those hubs may be incorporated into the hub of FIG. 20. In particular, the hub 710 may be non-ferrous and may be aluminium. The magnets of the rotor 700 are arranged in a Halbach array, such that there are radially polarised magnets 720, 740 polarised in alternating radially inwardly and radially outwardly directions and circumferentially polarised magnets 730, 750 arranged alternatingly between the radially polarised magnets 720, 740, the circumferentially polarised magnets 730, 750 being arranged alternatingly in clockwise and anti-clockwise directions.

In the arrangement of FIG. 20, the rotor 700 may have no ferrous posts, and magnets may be arranged between the teeth of the hub and also between adjacent magnets. The axially polarised and circumferentially polarised magnets may therefore have different axial lengths.

Generally, the Halbach array shown in FIG. 20 may replace the magnets and posts of any previously described subassembly.

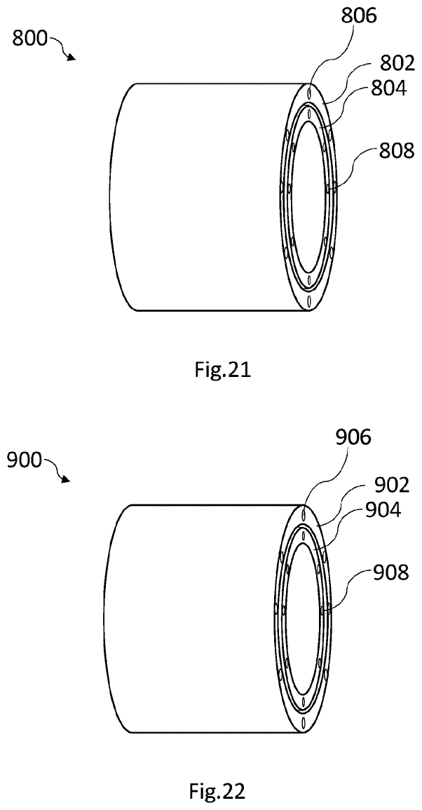

FIG. 21 shows an electric machine 800, which may be an electric motor or an electric generator, including a subassembly described above. The electric machine has a stator 802 and a rotor 804 concentrically inside the stator 802, the rotor 804 being movable relative to the stator 802. Stator connectors 806 and rotor connectors 808 are arranged at axial ends of the stator 802 and rotor 804 respectively. The stator 802 and rotor 804 may, by their respective connectors, be coupled to external members. The external members may be rotated, in the case of an electric motor, by the electric motor or may impart a torque to the electric machine in the case of a generator.

While the above descriptions relate to a rotor for use in ‘in-runner’ configurations, where the rotor is radially inside a stator, it will be understood that the subassembly may be changed as necessary to be used as a rotor in an ‘out runner’ configuration as shown in FIG. 22, where the rotor may be radially outside the stator. The electric machine 900 has a rotor 902, which may be substantially similar to any of the rotors described above, and a stator 904 arranged radially inside the rotor 902. The stator 904 has stator connectors 908 at an axial end, which are arranged to be fixed to a stationary external part, and the rotor 902 has rotor connectors 906 at an axial end which are arranged to be fixed to a moveable part.

In rotor 902, the teeth may extend radially inward from the hub and the magnets and posts may be tapered in order to tesselate with the posts and necessary, such that the magnets and posts may be exposed to a radially inner air gap, radially inside the rotor.

Further, while the subassembly may often be used as a rotor in the case of a brushless electric motor, the arrangement may also be used as a stator in the case of a brushed motor, where the subassembly may be held stationary and a changing magnetic field may be applied to an adjacent rotor.

While the above embodiments all discuss the use of magnets or permanent magnets, the magnets may be replaced by electromagnets, such as electrical coils, optionally with ferrous cores. Electromagnets and permanent magnets may be collectively described as magnetic elements.

The hub of any of the subassemblies may be formed as a single integral part or may be constructed as an assembly of multiple separately formed parts. For example, the teeth may be formed separately from and press fitted to the cylindrical core. Alternatively, the teeth may be formed on planar flanges which may be press fit onto a cylindrical centre portion.

In any of the above-described arrangements, the magnet-receiving gaps and post-receiving gaps may be interchanged, and the positions of the magnetic elements and posts may be swapped. The posts may be received axially between the teeth, with the magnetic elements circumferentially between the teeth.

Further, while the above-described subassemblies have exactly two sets of axially spaced teeth, other numbers of set of axially spaced teeth may be used. All of the subassemblies may be modified to increase the number of sets of axially spaced teeth, such as having three sets of axially spaced teeth, defining two axially spaced sets of magnet-receiving gaps, either side of a central set of teeth.

1. A subassembly for an electric machine, the subassembly comprising:
a hub comprising:
a first set of teeth, the first set of teeth defining post-receiving gaps between adjacent teeth of the first set of teeth; and;
a second set of teeth defining post-receiving gaps between adjacent teeth of the second set of teeth, the second set of teeth being spaced from the first set of teeth and defining magnet-receiving gaps therebetween;
a plurality of magnetic elements arranged within the magnet-receiving gaps; and
a plurality of ferrous posts arranged within the post-receiving gaps and between the plurality of magnetic elements.

2. The subassembly of claim 1, wherein the first set of teeth and the second set of teeth extend outwardly and have an outwardly extending extent substantially similar to an outwardly extending extent of the plurality of ferrous posts and/or of the plurality of magnetic elements.

3. The subassembly of claim 1, wherein the plurality of magnetic elements and/or the first set of teeth and the second set of teeth have a tapered shape, and wherein the plurality of magnetic elements and/or the first set of teeth and the second set of teeth each have a lateral width that is less at an outward location than at an inward location.

4. (canceled)

5. The subassembly of claim 1, wherein the plurality of magnetic elements, the first set of teeth, and the second set of teeth have cross-sectional areas matching in shape and size.

6. The subassembly of claim 1, wherein the plurality of ferrous posts have a tapered shape, and wherein the plurality of ferrous posts have a width that is greater at an outward location than at an inward location.

7. (canceled)

8. The subassembly of claim 1, wherein the hub is made from a non-ferrous material.

9. The subassembly of claim 1, wherein the post-receiving gaps have a tapered shape, having a greater width at an outward location and a smaller width at an inward location, and wherein the plurality of ferrous posts abut surfaces of the first set of teeth facing the post-receiving gaps and the surfaces of the second set of teeth facing the post-receiving gaps.

10. (canceled)

11. The subassembly of claim 1, further comprising a retaining ring arranged to maintain a position of the plurality of magnetic elements and/or the plurality of ferrous posts relative to the hub, wherein the retaining ring is a sleeve arranged to abut and/or cover a radially outer surface of each of the plurality of magnetic elements and the plurality of ferrous posts.

12. (canceled)

13. The subassembly of claim 1, wherein the plurality of magnetic elements and/or the plurality of ferrous posts comprise a stepped portion, the stepped portion having a surface arranged to receive a retaining member, wherein the stepped portions extend from bodies of the plurality of ferrous posts and/or the plurality of magnetic elements and have an outwardly extending extent less than that of the bodies, and wherein the first set of teeth and the second set of teeth comprise further stepped portions arranged to receive a retaining member.

14. (canceled)

15. (canceled)

16. The subassembly of claim 13, further comprising a retaining ring arranged to abut the stepped portions and/or the further stepped portions and to maintain a position of the plurality of magnetic elements and/or the plurality of ferrous posts relative to the hub.

17. The subassembly of claim 1, wherein the subassembly is symmetrical about a plane perpendicular to an axis through the subassembly.

18. The subassembly of claim 1, wherein each ferrous post, each magnetic element and/or the hub are formed integrally from a single piece.

19. The subassembly of claim 1, wherein each ferrous post and/or each magnetic element is laminated or segmented in a plane perpendicular to an axis through the subassembly.

20. The subassembly of claim 1, wherein each ferrous post has a recess arranged to face the hub, the recess being arranged to fix the ferrous post to the hub.

21. (canceled)

22. (canceled)

23. The subassembly of claim 1, wherein the plurality of ferrous posts and the plurality of magnetic elements are coupled to the hub by an adhesive and wherein the adhesive separates radially inner surfaces of the plurality of ferrous posts and radially inner surfaces of the plurality of magnetic elements from the hub.

24. The subassembly of claim 1, wherein surfaces of the plurality of magnetic elements and/or the plurality of ferrous posts of the sub-assembly are arranged to face an airgap of the electric machine into which the subassembly is to be incorporated, wherein the surfaces have been subject to a common post-assembly material removal process, to apply a common surface-dimension to the surfaces.

25. (canceled)

26. The subassembly of claim 1, wherein the subassembly is a rotor for a radial flux electric machine, wherein the rotor is arranged to be received inside a stator of the radial flux electric machine or wherein the rotor is arranged to house a stator therein.

27. (canceled)

28. (canceled)

29. A method of constructing a subassembly for an electric machine, the method comprising:
providing a hub, the hub comprising:
a first set of teeth, the first set of teeth defining post-receiving gaps between adjacent teeth of the first set of teeth, and
a second set of teeth, the second set of teeth defining post-receiving gaps between adjacent teeth of the second set of teeth, the second set of teeth being spaced from the first set of teeth and defining magnet-receiving gaps therebetween;
inserting a plurality of magnetic elements into the magnet-receiving gaps; and
inserting a plurality of ferrous posts between the plurality of magnetic elements.

30. The method of claim 29, wherein the plurality of magnetic elements and/or the plurality of ferrous posts comprise a stepped portion, the stepped portion having a surface arranged to receive a retaining member.

31. (canceled)

32. (canceled)

33. (canceled)

34. A subassembly for an electric machine, the subassembly comprising:
a hub comprising:
a first set of teeth, the first set of teeth defining first gaps between adjacent teeth of the first set of teeth; and;
a second set of teeth defining first gaps between adjacent teeth of the second set of teeth, the second set of teeth being spaced from the first set of teeth and defining second gaps therebetween; and
a plurality of magnetic elements arranged within the first gaps and the second gaps; wherein the plurality of magnetic elements are arranged in a Halbach array.

35. The subassembly of claim 34, wherein the plurality of magnetic elements comprise:
radially polarised magnetic elements arranged in the first gaps, circumferentially between the adjacent teeth of the first set of teeth and the adjacent teeth of the second set of teeth; and
circumferentially polarised magnetic elements arranged in the second gaps, axially between the first set of teeth and the second set of teeth.

36. (canceled)
